(19) United States
(12) Patent Application Publication
(10) Pub. No.: US 2023/0413355 A1
(43) Pub. Date: Dec. 21, 2023

(54) METHOD AND EQUIPMENT FOR MULTICAST TRANSMISSION

(71) Applicant: Samsung Electronics Co., Ltd., Gyeonggi-do (KR)

(72) Inventors: Hong WANG, Beijing (CN); He WANG, Beijing (CN); Lixiang XU, Beijing (CN); Weiwei WANG, Beijing (CN); Yiyan ZHANG, Beijing (CN)

(21) Appl. No.: 18/032,692

(22) PCT Filed: Oct. 19, 2021
(86) PCT No.: PCT/KR2021/014580

§ 371 Date: Apr. 19, 2023

(30) Foreign Application Priority Data
Oct. 21, 2020 (CN) 202011133947.1

(51) Int. Cl. H04W 76/15

(52) U.S. Cl. CPC H04W 76/15

(57) ABSTRACT

The present disclosure relates to a pre-5th-Generation (5G) or 5G communication system to be provided for supporting higher data rates Beyond 4th-Generation (4G) communication system such as Long Term Evolution (LTE). The present disclosure provides a method and equipment for multicast transmission, wherein the method for multicast transmission by a first network equipment comprises: sending, to a second network equipment, a first message for requesting for establishing a multicast transmission radio channel between the first network equipment and the second network equipment; and receiving, from the second network equipment, a second message in response to the first message requesting for establishing the multicast transmission radio channel between the first network equipment and the second network equipment.

### TECHNICAL FIELD

The application relates to wireless communication technology, in particular to an improved method and equipment for multicast transmission.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

Wireless communication is one of the most successful innovations in modern history. Recently, a number of subscribers of wireless communication services has exceeded 5 billion, and it continues growing rapidly. With the increasing popularity of smart phones and other mobile data equipment (such as tablet computers, notebook computers, netbooks, e-book readers and machine-type equipment) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

In the prior art, there is a demand for how to establish multicast services in various multicast transmission modes.

### Solution to Problem

According to an aspect of the present disclosure, there is provided a method for multicast transmission by a first network equipment, comprising: sending, to a second network equipment, a first message for requesting for establishing a multicast transmission radio channel between the first network equipment and the second network equipment; and receiving, from the second network equipment, a second message in response to the first message requesting for establishing the multicast transmission radio channel between the first network equipment and the second network equipment.

According to an embodiment of the present disclosure, the method further comprises: sending, to a third network equipment, a third message for requesting for establishing a multicast transmission radio channel between the first network equipment and the third network equipment; and receiving, from the third network equipment, a fourth message in response to the third message requesting for establishing a multicast transmission radio channel between the first network equipment and the third network equipment.

According to an embodiment of the present disclosure, wherein the first message sent to the second network equipment includes information about configuration of a point-to-point multicast transmission radio channel.

According to an embodiment of the present disclosure, wherein the first message sent to the second network equipment includes information about configuration of a point-to-point multicast transmission radio channel and information about configuration of a point-to-multipoint multicast transmission radio channel.

According to an embodiment of the present disclosure, wherein the information about the configuration of the point-to-point multicast transmission radio channel and the information about the configuration of the point-to-multipoint multicast transmission radio channel have the same identity information.

According to an embodiment of the present disclosure, wherein the third message sent to the third network equipment includes information about configuration of a point-to-point multicast transmission radio channel.

According to an embodiment of the present disclosure, wherein the third message sent to the third network equipment includes information about configuration of point-to-point and point-to-multipoint multicast transmission radio channels.

According to an embodiment of the present disclosure, it further comprises: sending, to the second network equipment, a fifth message for requesting for establishing a point-to-multipoint multicast transmission radio channel between the first network equipment and the second network equipment; wherein the fifth message sent to the second network equipment includes information about the configuration of the point-to-multipoint multicast transmission radio channel.

According to an embodiment of the present disclosure, it further comprises sending, to the third network equipment, a sixth message for requesting for establishing the point-to-multipoint multicast transmission radio channel between the first network equipment and the third network equipment, wherein the sixth message sent to the third network equipment includes information about the configuration of the point-to-multipoint multicast transmission radio channel.

According to another aspect of the present disclosure, there is provided a first network equipment for multicast transmission comprising: a transceiver configured to transmit and receive signals; and a processor configured to perform the method of the present disclosure.

According to another aspect of the present disclosure, there is provided a method for multicast transmission by a first network equipment, comprising: determining a multicast transmission mode to be adopted by referring to information about cell signal quality; and notifying a second network equipment of information about the multicast transmission mode, wherein the information about the multicast transmission mode includes information about whether a channel mode is point-to-point or point-to-multipoint.

According to an embodiment of the present disclosure, it further comprises: notifying a third network equipment of the information about the multicast transmission mode.

According to an embodiment of the present disclosure, wherein the information about the multicast transmission mode is notified to the third network equipment via the second network equipment.

According to an embodiment of the present disclosure, wherein the first network equipment is a CU-CP, the second network equipment is a DU, and the third network equipment is a CU-UP; or wherein the first network equipment is a CU-UP, the second network equipment is a DU, and the third network equipment is a CU-CP; or wherein the first network equipment is a DU, the second network equipment is a CU-UP, and the third network equipment is a CU-CP.

According to an embodiment of the present disclosure, wherein the first network equipment is a CU-UP, the second network equipment is a CU-CP, and the third network equipment is a DU; or wherein the first network equipment is a DU, the second network equipment is a CU-CP, and the third network equipment is a CU-UP.

According to another aspect of the present disclosure, there is provided a first network equipment for multicast transmission comprising: a transceiver configured to receive and transmit signals; and a controller configured to perform the method of the present disclosure.

### Advantageous Effects of Invention

The present disclosure provides a method and equipment for multicast transmission. It can avoid or reduce the extra overhead of multicast data transmission, improve utilization efficiency of access network resources and/or air interface resources, reduce transmission delay, reduce data loss when the multicast transmission mode is switched, and reduce delay caused by transmission mode switch.

### BRIEF DESCRIPTION OF DRAWINGS

FIG. 1 is a system architecture diagram of system architecture evolution (SAE);

FIG. 2 is a schematic diagram of the initial overall architecture of 5G;

FIG. 3 is a schematic diagram of embodiment 1 of the present disclosure;

FIG. 4 is a schematic diagram of embodiment 2 of the present disclosure;

FIG. 5 is a schematic diagram of embodiment 3 of the present disclosure;

FIG. 6 is a schematic diagram of embodiment 4 of the present disclosure;

FIG. 7 is a schematic diagram of embodiment 5 of the present disclosure;

FIG. 8 is a schematic diagram of embodiment 6 of the present disclosure;

FIG. 9 is a schematic diagram of embodiment 7 of the present disclosure;

FIG. 10 is a schematic diagram of embodiment 8 of the present disclosure;

FIG. 11 is a block diagram of a network equipment of the present disclosure.

### MODE FOR THE INVENTION

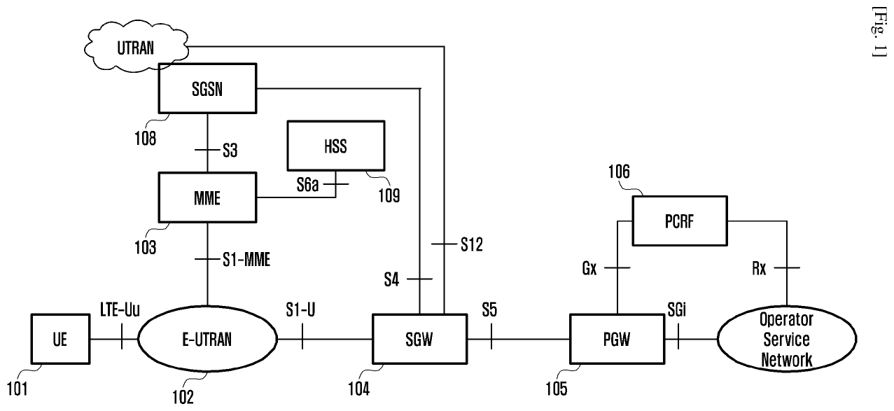

FIGS. 1 to 11 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or equipment.

FIG. 1 is an exemplary system architecture 100 of system architecture evolution (SAE). User equipment (UE) 101 is a terminal equipment for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node equipment that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

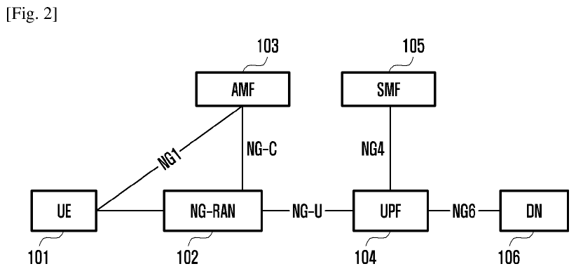

FIG. 2 is an exemplary system architecture 200 according to various embodiments of the present disclosure. Other embodiments of the system architecture 200 can be used without departing from the scope of the present disclosure.

User equipment (UE) 201 is a terminal equipment for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In the following embodiments, the 5G system is taken as an example, the access network control plane takes CU-CP (centralized unit-control plane) as an example, the access network user plane takes CU-UP (centralized unit-user plane) as an example, and the distributed unit takes DU (distributed unit) as an example. The method is also applicable to corresponding entities of other systems.

In the prior art, there is a demand for how to establish multicast services of various multicast transmission modes and how to switch between multicast services of various multicast transmission modes.

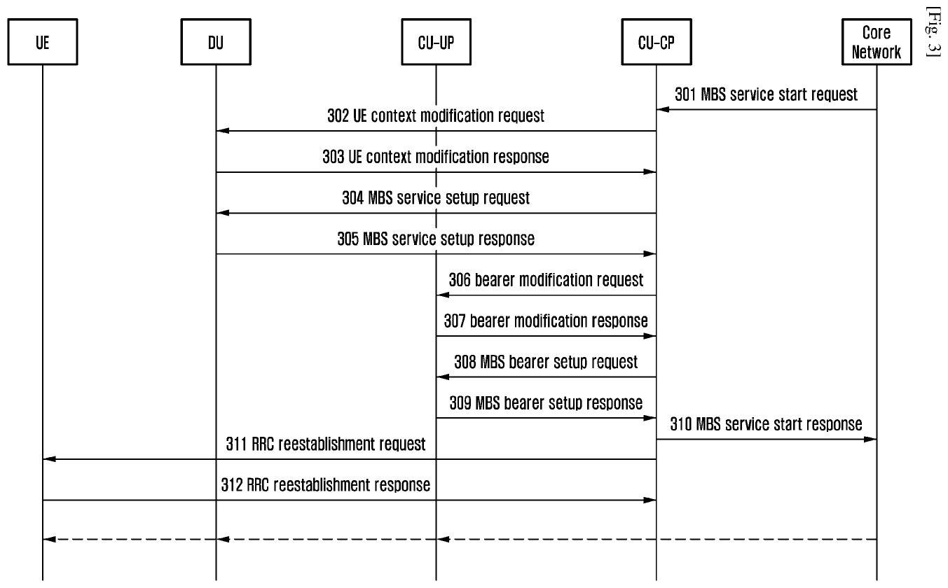

FIG. 3 is a schematic diagram of embodiment 1 of the present disclosure.

A method for a process of establishing multicast service is shown in FIG. 3 (embodiment 1). Embodiment 1 describes a process of establishing a point-to-point bearer and/or a point-to-multipoint bearer among a core network, a RAN and a UE to transmit multicast broadcast service data when the multicast broadcast service starts. The method mainly comprises the following steps: establishing a point-to-point channel and indicating information of a point-to-multipoint channel through a UE-specific process, and transmitting particular configuration information of a point-to-multipoint channel through common signalling, among various nodes of the RAN.

Here, the detailed description of the steps unrelated to the present disclosure is omitted, and the description starts from an AMF of the core network initiating a multicast broadcast service (hereinafter referred to as MBS for simplicity) message to the access network. The method comprises the following steps:

Step 301, the core network, such as the AMF, initiates an MBS start request message to a control plane node (hereinafter referred to as CU-CP) of the RAN.

The MBS start request message carries a multicast service identity, which uniquely indicates an MBS. For example, the service identity is set to a temporary multicast group identity TMGI. The message carries the quality requirements of the service and a multicast address of service, and the message can also carry a protocol data unit (PDU) session identity corresponding to the multicast service, and the PDU session identity is used to identify the corresponding packet data during the point-to-point transmission of MBS data.

Step 302, the CU-CP sends a UE context setup request, or a UE context modification request, or other UE-specific messages to the DU.

The message is used to establish a point-to-point channel of an MBS between CU-UP and DU. The message carries the identity of the UE on the interface between CU-CP and DU, and the message carries configuration information of data radio channel (for example, data radio bearer DRB) of the UE. DRB is a point-to-point channel used to transmit MBS data. The configuration information of DRB includes an identity of the DRB and information of the data flow (QoS flow) corresponding to the DRB. If the DRB is used to transmit data of the MBS, the QoS flow information is the QoS flow information included in a session connection of a certain MBS, including an identity of the QoS flow and quality requirements of the QoS flow, etc. The configuration information of the DRB also includes both the configuration information of the SDAP layer of the DRB and the PDCP layer of the DRB. Herein, the configuration information of the PDCP layer of the DRB includes configuration of a PDCP SN length, a RLC mode, a discarding clock and a sorting clock, etc. In order for the DU to get a relation between the point-to-point channel and the point-to-multipoint channel, the configuration information of the DRB may also include an identity of the MBS or an identity of a point-to-multipoint radio channel (for example, MBS radio bearer, hereinafter referred to as MRB for simplicity). If the configuration information of the DRB includes the identity of the MBS or the identity of the MRB, it indicates that the DRB is used to transmit the MBS data. The identity of the MRB is the unique identity of the point-to-multipoint radio channel that transmits the MBS. For an MBS, the point-to-multipoint radio channel is a channel which is established with respect to the MBS, and all UE that needs to receive the service receives data from the MRB. An MRB can be established in a cell for receiving a certain MBS, or an MRB can be established within the same CU-CP for receiving a certain MBS.

After receiving the message, the DU saves the content of the message, configures the RLC mode according to the configuration information, assigns downlink data receiving tunnel information to the DRB for point-to-point transmission, and receives the data sent by the CU-UP from the tunnel. Alternatively, for the same MBS, the DU assigns a tunnel for the MBS. No matter whether it is point-to-point transmission or point-to-multipoint transmission, the CU-UP sends data to the DU from the tunnel, and the DU receives data from the same tunnel, and then sends the data to the corresponding protocol for processing according to the setting of the transmission mode.

Step 303, the DU sends a response message to step 302, such as sending a UE context modification response message.

The message carries an identity of the successfully established DRB, and includes downlink data receiving tunnel information assigned by the DU for the DRB. If the DRB is used to transmit the MBS, the message may also include a service identity of the MRB. The DU receives MBS data sent by CU-UP from the tunnel.

Step 304, the CU-CP sends an MBS setup request message to the DU.

The message is used to establish a point-to-multipoint channel of the MBS between the CU-UP and the DU. The message carries the configuration information of the MBS point-to-multipoint channel. The configuration information of the MBS point-to-multipoint channel includes the identity of an MBS radio data channel MRB, an MBS identity, information of data flow(s) (QoS flow) corresponding to the MRB, SDAP configuration of the MRB and PDCP configuration. Herein, the PDCP configuration includes configuration of a PDCP SN length, a RLC mode, a discarding clock and a sorting clock, etc.

After receiving the message, the DU saves the content of the message, configures the RLC mode according to the configuration information, assigns the same downlink data receiving tunnel information to users in the same cell, and receives MBS data of the point-to-multipoint transmission from the CU-UP through the tunnel. The tunnel information assigned by the DU in this step may be the same information as the tunnel information sent by the DU to the CU-CP in Step 303.

Step 305, the DU sends an MBS setup response message to the CU-CP.

The message carries the identity of the successfully established MRB or the identity of the MBS, and includes downlink data receiving tunnel information assigned by the DU for the MRB or MBS. The DU receives MBS data sent by the CU-UP from this tunnel.

Step 306, the CU-CP sends a bearer setup request or a bearer modification request message to the user plane node (hereafter, referred to as CU-UP for simplicity) of the RAN.

The message is used to establish resources for the point-to-point channel corresponding to a certain MBS on the CU-UP, and is a UE-specific message. The message carries the identity of UE on the interface between the CU-CP and the CU-UP, including an identity of the MBS, an identity of the DRB, the SDAP configuration and the PDCP configuration.

If the point-to-point channel and the point-to-multipoint channel share the same PDCP and/or SDAP, the PDCP and/or the SDAP corresponding to the MBS can be configured in a common message. In order to associate the point-to-point channel and the point-to-multipoint channel with the MBS, the message in Step 306 includes a piece of new information, which includes the identity of the MBS and the identity of the DRB of the point-to-point channel.

Step 307, the CU-UP sends a response message to Step 306, such as a bearer modification response message.

The message carries the identity of UE on the interface between CU-CP and CU-UP, including the identity of the MBS and the identity of the successfully established DRB.

Step 308, the CU-CP sends an MBS bearer setup request message to the CU-UP.

The message is used to establish resources corresponding to a certain MBS on CU-UP. The message is a non-UE-specific message, which is with respect to a certain MBS. The message carries the identity of the MBS, including the identity of the MRB, the SDAP configuration and the PDCP configuration. If the point-to-point channel and the point-to-multipoint channel share the same PDCP and/or SDAP, the PDCP and/or the SDAP corresponding to the MBS can be configured in the message.

Step 309, the CU-UP sends an MBS bearer setup response message to the CU-CP.

The message carries the identity of UE on the interface between the CU-CP and the CU-UP, including the identity of the MBS and the identity of the MRB successfully established. The message also includes the downlink data receiving tunnel information assigned by the CU-UP for the MBS.

Step 310, the CU-CP sends an MBS start response message to the core network.

The message is used to acknowledge the successful establishment of MBS resources on the RAN. The message includes the service identity of the MBS successfully established, and may also include the downlink data receiving tunnel information assigned by the CU-UP.

Step 311, the CU-CP sends a RRC reestablishment request message to the UE.

The message is used to establish relevant configuration of the MBS at UE side. Configuration information of the DRB and/or configuration information of the MRB may be included.

Step 312, the UE sends a RRC reestablishment response message to the CU-CP.

The message is used by the UE to notify the MBS configuration success at the UE side. The message includes the identity of the successfully established DRB and/or the identity of the successfully established MRB.

Meanwhile, some of the steps of FIG. 3 described above may be omitted or preceded in advance according to another procedure. However, the procedures illustrated in FIG. 3 are exemplified to clearly convey what is intended to be described in the present disclosure. Accordingly, even if some procedures illustrated in FIG. 3 are omitted, those skilled in the art can sufficiently achieve the effects according to the object of the present invention by using the present disclosure.

With this embodiment, extra overhead of multicast data transmission can be avoided or reduced, utilization efficiency of access network resources and/or air interface resources can be improved, transmission delay can be reduced, and data loss can be reduced.

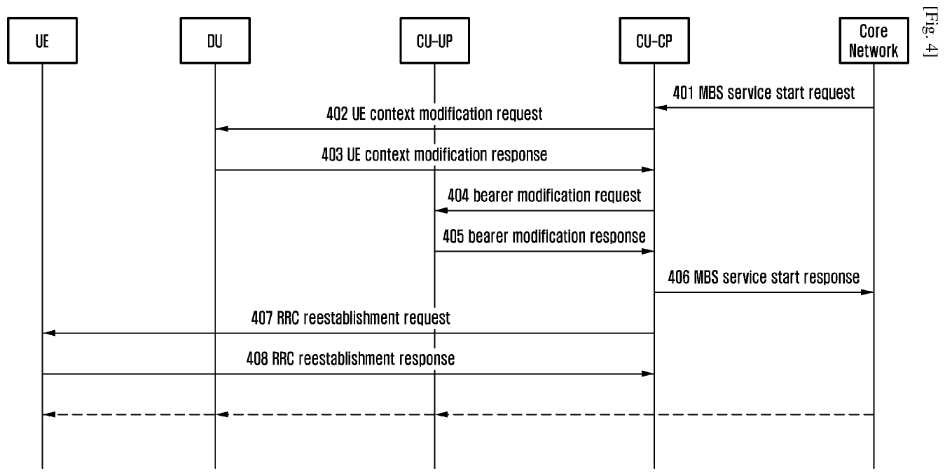

FIG. 4 is a schematic diagram of embodiment 2 of the present disclosure.

Another method for a process of establishing multicast service is shown in FIG. 4 (embodiment 2). Embodiment 2 describes a process of establishing a point-to-point bearer and/or a point-to-multipoint bearer among a core network, a RAN and a UE to transmit multicast broadcast service data when the multicast broadcast service starts. The method mainly comprises the following steps: establishing a point-to-point channel through a UE-specific process and transmitting particular configuration information of a point-to-multipoint channel through a UE-specific process, among various nodes of the RAN.

Here, the detailed description of the steps unrelated to the present disclosure is omitted, and the description starts from an AMF of the core network initiating a multicast broadcast service (hereinafter referred to as MBS for simplicity) message to the access network. The method comprises the following steps:

Step 401, the core network initiates an MBS start request message to a control plane node (hereinafter referred to as CU-CP) of RAN.

The message carries a multicast service identity, and the service identity uniquely indicates an MBS, for example, the service identity is set to a temporary multicast group identifier TMGI. The message carries the quality requirements of the service and a multicast address of the service, and the message can also carry a protocol data unit (PDU) session identity corresponding to the multicast service, and the PDU session identity is used to identify the corresponding packet data during the point-to-point transmission of MBS data.

Step 402, the CU-CP sends a UE context setup request message, or a UE context modification request message, or other UE-specific message to the DU.

Particularly, three methods for configuring both the configuration of point-to-point data radio bearer and point-to-multipoint radio bearer are proposed.

In the first method, the message in Step 402 includes both the configuration of point-to-point data radio bearer and the configuration of point-to-multipoint radio bearer.

The both are associated with each other by the same identity information. The configuration of point-to-point data radio bearer is an information element already defined in the current UE context setup request or UE context setup modification message, and the configuration of point-to-multipoint radio bearer is a newly added information element. Particularly:

The message carries the configuration information of a point-to-point data channel (e.g., DRB) of the UE. The configuration information of the DRB includes an identity of the DRB and information of data flow(s) (QoS flow) corresponding to the DRB. The QoS flow information is QoS flow information included in a certain MRB session if the DRB is used to transmit data of MRB. The configuration information of the DRB also includes both configuration information of the SDAP layer of the DRB and configuration information of the PDCP layer of the DRB. Herein, the configuration information of the PDCP layer of the DRB includes configuration of a PDCP SN length, a RLC mode, a discarding clock and a sorting clock, etc. The configuration information of the DRB may also include the identity of the MBS or the identity of the MRB. If the identity of the MBS or the identity of the MRB is included, it indicates that the DRB is used to transmit data of the MBS.

The message also carries the configuration information of the MBS point-to-multipoint channel. The configuration information of the MBS point-to-multipoint includes the identity of MBS radio data channel (for example, MBS radio bearer, referred to as MRB for short), the identity of the MBS corresponding to the MRB, information of data flow(s) (QoS flow) corresponding to the MRB, the SDAP configuration of the MRB and the PDCP configuration. Among them, the PDCP configuration includes configuration of a PDCP SN length, a RLC mode, a discarding clock and a sorting clock, etc.

If the point-to-point channel and the point-to-multipoint channel share the same protocol stacks of the SDAP and the PDCP, for the configuration information in the DRB, the SDAP and the PDCP configuration are the same, and only the RLC modes are different.

After receiving the message, the DU saves the content of the message, configures the RLC mode according to the configuration information, assigns a piece of information of the downlink data receiving tunnel for the point-to-point transmission mode and assigns another piece information of the downlink data receiving tunnel for the point-to-multipoint transmission mode, and receives MBS data of the point-to-point transmission or MBS data of the point-to-multipoint transmission from the CU-UP through different tunnels, respectively. Among them, for different users, the assigned point-to-multipoint tunnel information is the same, and the point-to-multipoint data is received through the same tunnel. Alternatively, one piece of downlink data receiving tunnel information is assigned for the point-to-point transmission mode and the point-to-multipoint transmission mode, no matter whether it is point-to-point or point-to-multipoint. Users in the same cell receive MBS data from one tunnel.

In the second method, the configuration information of the point-to-multipoint is included in the configuration information of the point-to-point. This method does not need to add a separate information element for point-to-multipoint. Particularly:

The message carries the configuration information of the data channel DRB of the UE. The data channel is a point-to-point channel for transmitting MBS data. The configuration information of the DRB includes the identity of the DRB and the information of the data flow(s) (QoS flow) corresponding to the DRB. The QoS flow information is QoS flow information included in a certain MRB session if the DRB is used to transmit data of the MRB. The configuration information of the DRB also includes both the configuration information of the SDAP layer of the DRB and the configuration information of the PDCP layer of DRB. The point-to-point transmission and the point-to-multipoint transmission share the same protocol stack of the SDAP and the PDCP, so only the SDAP layer configuration information and the PDCP layer configuration information are included in the configuration of the DRB. Herein, the configuration information of the PDCP layer of the DRB includes configuration of a PDCP SN length, a RLC mode, a discarding clock and a sorting clock, etc. The configuration information of the DRB also includes the identity of the MBS and the RLC mode of the MBS point-to-multipoint transmission.

After receiving the message, the DU saves the content of the message, configures the RLC mode according to the configuration information, assigns different downlink data receiving tunnel information to users in the same cell, and receives MBS data of the point-to-point transmission or MBS data of the point-to-multipoint transmission from the CU-UP through the tunnel, respectively. Alternatively, users in the same cell are assigned the same downlink data receiving tunnel information, and MBS data of the point-to-point transmission or MBS data of the point-to-multipoint transmission are received from the CU-UP through the tunnel, respectively.

In the third method, a configuration information element of the MBS is newly defined in a message. In such configuration, the configuration of the point-to-multipoint channel and the point-to-point channel of the MRB services are included. Particularly:

The message carries the configuration information of the MBS point-to-multipoint channel. The configuration information of the MBS point-to-multipoint channel includes the identity of the MBS radio data channel (for example, MBS radio bearer, referred as to MRB for short), the identity of the MBS corresponding to the MRB, information of data flow(s) (QoS flow) corresponding to the MRB, the SDAP configuration of the MRB and the PDCP configuration. Herein, the PDCP configuration includes configuration of a PDCP SN length, a RLC mode, a discarding clock and a sorting clock, etc. The message also includes the DRB channel identity of the point-to-point channel and the RLC mode corresponding to the point-to-point channel.

After receiving the message, DU saves the content of the message, configures the RLC mode according to the configuration information, assigns the downlink data receiving tunnel information for users. With regard to the same MBS, the DU assigns the same downlink data receiving tunnel information for all users, and receives MBS data of the point-to-point transmission or MBS data of the point-to-multipoint transmission from this tunnel.

Step 403, the DU sends the response message to step 402 to the CU-CP, such as sending a UE context modification response message to the CU-CP.

The message carries the identity of the successfully established DRB, and includes the downlink data receiving tunnel information assigned for the DRB or the downlink data receiving tunnel information assigned for the MBS by the DU. The message may also include the service identity of the MRB. The DU receives the MBS data sent by the CU-UP from the tunnel.

The CU-CP receives the response message, saves the information, and sends the tunnel information assigned by the DU for MBS to the CU-UP through the following process.

Step 404, the CU-CP sends a bearer setup request or a bearer modification request message to the CU-UP.

The message is used to establish resources corresponding to a certain MBS on the CU-UP, and the message is a UE-specific message, which carries the identity of the UE on the interface between the CU-CP and the CU-UP. The message also carries the identity of the MBS, including the identity of the MRB, the SDAP configuration and the PDCP configuration of the point-to-multipoint channel and/or the SDAP configuration and the PDCP configuration of the point-to-point channel. If the point-to-point channel and the point-to-multipoint channel share the same PDCP and/or SDAP, the PDCP and/or SDAP corresponding to the MBS can be configured in the message. The message also carries the downlink data receiving tunnel information assigned by the DU.

Step 405, the CU-UP sends a bearer setup response or a bearer modification response message to the CU-CP.

The message carries the identity of UE on the interface between the CU-CP and the CU-UP, the message also carries the identity of the MBS, includes the identity of the MRB successfully established. The message also includes the downlink data receiving tunnel information assigned by the CU-UP for the MBS.

Step 406, the CU-CP sends an MBS start response message to the core network.

The message is used to acknowledge the MBS resources successfully established on the RAN. The message includes the service identity of the MBS successfully established, and may also include the downlink data receiving tunnel information assigned by the CU-UP.

Step 407, the CU-CP sends an RRC reestablishment request message to the UE.

The message is used to establish the relevant configuration of the MBS at UE side. The message may include the configuration information of the DRB and/or the configuration information of the MRB.

Step 408, the UE sends an RRC reestablishment response message to the CU-CP.

The message is used by the UE to inform MBS configuration success at the UE side. The message includes the identity of the successfully established DRB and/or the identity of the successfully established MRB.

Meanwhile, some of the steps of FIG. 4 described above may be omitted or preceded in advance according to another procedure. However, the procedures illustrated in FIG. 4 are exemplified to clearly convey what is intended to be described in the present disclosure. Accordingly, even if some procedures illustrated in FIG. 4 are omitted, those skilled in the art can sufficiently achieve the effects according to the object of the present invention by using the present disclosure.

With this embodiment, extra overhead of multicast data transmission can be avoided or reduced, utilization efficiency of access network resources and/or air interface resources can be improved, transmission delay can be reduced, and data loss can be reduced.

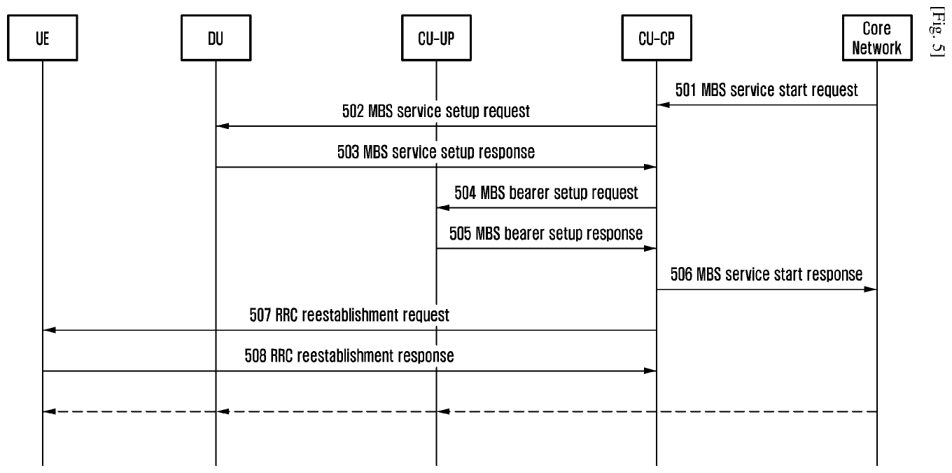

FIG. 5 is a schematic diagram of embodiment 3 of the present disclosure.

Another method for a process of establishing multicast service is shown in FIG. 5 (embodiment 3). Embodiment 3 describes a process of establishing a point-to-point bearer and/or a point-to-multipoint bearer among a core network, a RAN and a UE to transmit multicast broadcast service data when the multicast broadcast service starts. The method mainly comprises the following steps: establishing a point-to-point channel through a common process and transmitting particular configuration information of the point-to-multipoint channel through a common process, among various nodes of the RAN.

Here, the detailed description of the steps unrelated to the present disclosure is omitted, and the description starts from an AMF of the core network initiating a multicast broadcast service (hereinafter, referred to as MBS for simplicity) message to the access network. The method comprises the following steps:

Step 501, the core network initiates an MBS start request message to a control node of RAN (hereinafter referred to as CU-CP).

The message carries a multicast service identity, and the service identity uniquely indicates an MBS, for example, the service identity is set to a temporary multicast group identifier TMGI. The message carries quality requirements of the service and a multicast address of the service. The message may also carry a protocol data unit (PDU) session identity corresponding to the multicast service, and the PDU session identity is used to identify corresponding packet data during MBS data of a point-to-point transmission.

Step 502, the CU-CP sends an MBS setup request message to the DU.

The message is used to establish a point-to-multipoint channel and a point-to-point channel of the MBS between the CU-UP and the DU. The message in Step 502 includes both the configuration of point-to-point data radio bearer and the configuration of point-to-multipoint radio bearer. The both are associated with each other by the same identity information. Particularly:

The message carries the configuration information of the MBS point-to-multipoint channel. The configuration information of the MBS point-to-multipoint channel includes an identity of the MBS radio data channel (MBS radio bearer, referred to as MRB for short), an identity of the MBS corresponding to the MRB, information of data flow(s) (QoS flow) corresponding to the MRB, SDAP configuration of the MRB and PDCP configuration. Herein, the PDCP configuration includes configuration of a PDCP SN length, a RLC mode, a discarding clock and a sorting clock, etc.

The message carries a UE list including information of all users who want to receive MBS, or information of all users corresponding to the above MRB. The information of users includes an identity of UE and configuration information of the point-to-point data channel DRB. The identity of the UE can be, for example, the RAN UE ID that uniquely identifies the UE in the RAN. The configuration information of the DRB includes the identity of the DRB and the information of the data flow(s) (QoS flow) corresponding to the DRB. The QoS flow information is QoS flow information included in a certain MRB session if the DRB is used to transmit data of the MRB. The configuration information of the DRB also includes both the configuration information of the SDAP layer of the DRB and the configuration information of the PDCP layer of the DRB. Among them, the configuration information of the PDCP layer of the DRB includes configuration of a PDCP SN length, a RLC mode, a discarding clock and a sorting clock, etc. The configuration information of the DRB may also include the identity of the MBS or the identity of the MRB. If the identity of the MBS or the identity of the MRB is included, it indicates that the DRB is used to transmit data of the MBS.

After receiving the message, the DU saves the content of the message, assigns downlink data receiving tunnel information for the MBS, and receives MBS data of the point-to-point transmission or MBS data of the point-to-multipoint transmission from the CU-UP through the tunnel. Step 503, the DU sends the response message to step 502 to the CU-CP, for example, sends an MBS setup response message to the CU-CP.

The message carries the identity of the successfully established MRB or MBS, and includes the downlink data receiving tunnel information assigned by the DU for the MRB or MBS. The DU receives MBS data sent by CU-UP from this tunnel.

The CU-CP receives the response message, saves the information, and sends the tunnel information assigned for the MBS by the DU to the CU-UP through the following process.

Step 504, the CU-CP sends an MBS bearer setup request or an MBS bearer modification request message to the CU-UP.

The message is used to establish resources corresponding to a certain MBS on the CU-UP, and the message is a UE-specific message, which carries the identity of the UE on the interface between the CU-CP and the CU-UP. The message also carries the identity of the MBS, includes the identity of the MRB, the SDAP configuration and the PDCP configuration of the point-to-multipoint channel and/or the SDAP configuration and the PDCP configuration of the point-to-point channel. If the point-to-point channel and the point-to-multipoint channel share the same PDCP and/or SDAP, the PDCP and/or SDAP corresponding to the MBS can be configured in the message. The message also carries the downlink data receiving tunnel information assigned by the DU.

Step 505, the CU-UP sends an MBS bearer setup response or an MBS bearer modification response message to the CU-CP.

The message carries the identity of UE on the interface between the CU-CP and the CU-UP, the message also carries the identity of the MBS, includes the identity of the MRB successfully established. The message also includes the downlink data receiving tunnel information assigned for the MBS by the CU-UP.

Step 506, the CU-CP sends an MBS start response message to the core network.

The message is used to acknowledge successful establishment of the MBS resources on the RAN. The message includes the service identity of the MBS successfully established, and may also include the downlink data receiving tunnel information assigned by the CU-UP.

Step 507, the CU-CP sends an RRC reestablishment request message to the UE.

The message is used to establish relevant configuration of the MBS at the UE side, and may include configuration information of the DRB and/or configuration information of the MRB.

Step 508, the UE sends an RRC reestablishment response message to the CU-CP.

The message is used by the UE to inform the MBS configuration success at the UE side. The message includes the identity of the successfully established DRB and/or the identity of the successfully established MRB.

Meanwhile, some of the steps of FIG. 5 described above may be omitted or preceded in advance according to another procedure. However, the procedures illustrated in FIG. 5 are exemplified to clearly convey what is intended to be described in the present disclosure. Accordingly, even if some procedures illustrated in FIG. 5 are omitted, those skilled in the art can sufficiently achieve the effects according to the object of the present invention by using the present disclosure.

With this embodiment, extra overhead of multicast data transmission can be avoided or reduced, utilization efficiency of access network resources and/or air interface resources can be improved, transmission delay can be reduced, and data loss can be reduced.

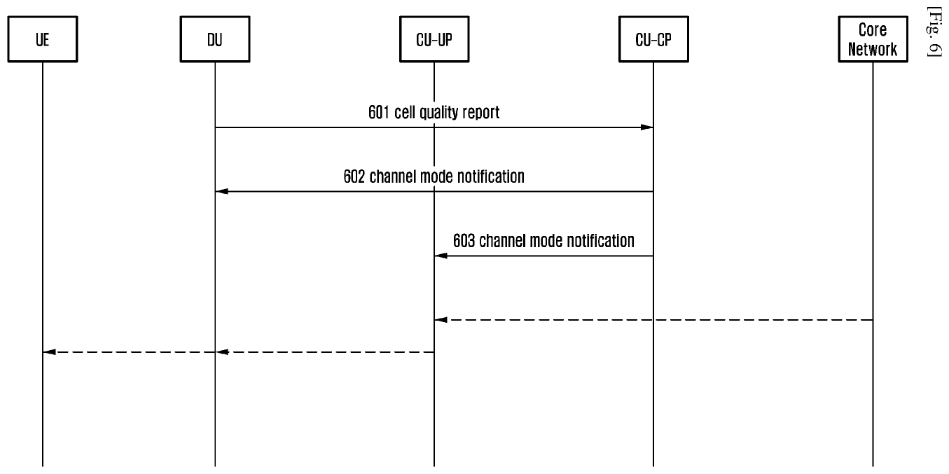

FIG. 6 is a schematic diagram of embodiment 4 of the present disclosure.

An embodiment of a method for switching multicast transmission mode according to the present disclosure is shown in FIG. 6 (embodiment 4). The multicast transmission mode may include a point-to-point transmission mode and a point-to-multipoint transmission mode, and it can be switched between the two modes. In this method, the CU-CP decides which mode is adopted, and informs the DU and the CU-UP of the mode. A detailed description of steps unrelated to the present disclosure is omitted here. The method comprises the following steps:

Step 601, the DU sends a cell signal quality report message to the CU-CP.

The cell signal quality report can be sent to the CU-CP through the control plane. Cell signal quality can be indicated by various information, such as a reference signal receiving power (RSRP), a reference signal receiving quality (RSRQ), a data receiving success probability, times of data retransmission, and/or an indication indicating a signal quality (for example, a good signal quality, a poor signal quality or a signal quality level), etc.

Step 602, the CU-CP decides which channel mode is adopted to transmit the MBS, and sends a channel mode notification information to the DU, and the channel mode can indicate whether it is a point-to-point transmission mode or a point-to-multipoint transmission mode. The CU-CP can make decision according to user data, according to cell signal quality.

Step 603, the CU-CP may notify the CU-UP of the decision. The channel mode notification information is sent to the CU-UP, and the channel mode can indicate whether it is a point-to-point transmission mode or a point-to-multipoint transmission mode. According to the indication information, the CU-UP can send data to the DU through different tunnels.

Meanwhile, some of the steps of FIG. 6 described above may be omitted or preceded in advance according to another procedure. However, the procedures illustrated in FIG. 6 are exemplified to clearly convey what is intended to be described in the present disclosure. Accordingly, even if some procedures illustrated in FIG. 6 are omitted, those skilled in the art can sufficiently achieve the effects according to the object of the present invention by using the present disclosure.

With this embodiment, when the multicast transmission mode is switched, extra overhead of multicast data transmission can be avoided or reduced, utilization efficiency of access network resources and/or air interface resources can be improved, transmission delay can be reduced, data loss can be reduced, and delay caused by the switch of the transmission mode can be reduced.

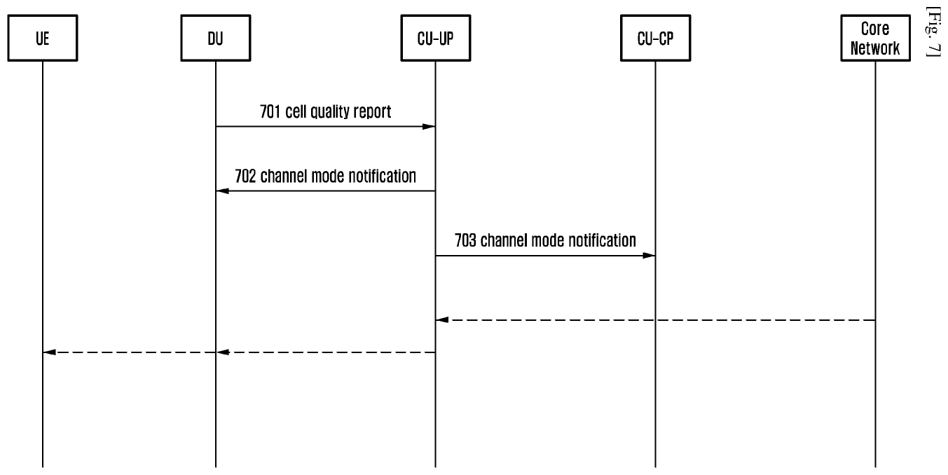

FIG. 7 is a schematic diagram of embodiment 5 of the present disclosure.

An embodiment of a method for switching multicast transmission mode according to the present disclosure is shown in FIG. 7 (embodiment 5). The multicast transmission mode may include a point-to-point transmission mode and a point-to-multipoint transmission mode, and it can be switched between the two modes. In this method, the CU-UP decides which mode is adopted, and informs the DU and the CU-CP of the mode. A detailed description of steps unrelated to the present disclosure is omitted here. The method comprises the following steps:

Step 701, the DU sends a cell signal quality report message to the CU-UP.

The cell signal quality can be indicated by various information, such as a reference signal receiving power (RSRP), a reference signal receiving quality (RSRQ), a data receiving success probability, times of data retransmission, and/or an indication indicating a signal quality (for example, a good signal quality, a poor signal quality or a signal quality level), etc. The cell signal quality report can be sent to the CU-UP through the user plane. The decision is made by the CU-UP, the CU-UP doesn't know the quality of the cell. If decision of the channel mode needs to refer to the cell signal quality, the DU can send the cell signal quality to the CU-UP through the user plane, or the CU-UP can get the cell signal quality from the message sent by the CU-CP.

Step 702, the CU-UP decides which channel mode is adopted to transmit the MBS, and sends a channel mode notification message to the DU. The channel mode can indicate whether it is a point-to-point transmission mode or a point-to-multipoint transmission mode, and is sent to the DU through the user plane.

Step 703, the CU-UP may notify the CU-CP of the decision. The CU-UP sends the channel mode notification information to the CU-CP, and the channel mode can indicate whether it is a point-to-point transmission mode or a point-to-multipoint transmission mode.

Meanwhile, some of the steps of FIG. 7 described above may be omitted or preceded in advance according to another procedure. However, the procedures illustrated in FIG. 7 are exemplified to clearly convey what is intended to be described in the present disclosure. Accordingly, even if some procedures illustrated in FIG. 7 are omitted, those skilled in the art can sufficiently achieve the effects according to the object of the present invention by using the present disclosure.

With this embodiment, when the multicast transmission mode is switched, extra overhead of multicast data transmission can be avoided or reduced, utilization efficiency of access network resources and/or air interface resources can be improved, transmission delay can be reduced, data loss can be reduced, and delay caused by the switch of the transmission mode can be reduced.

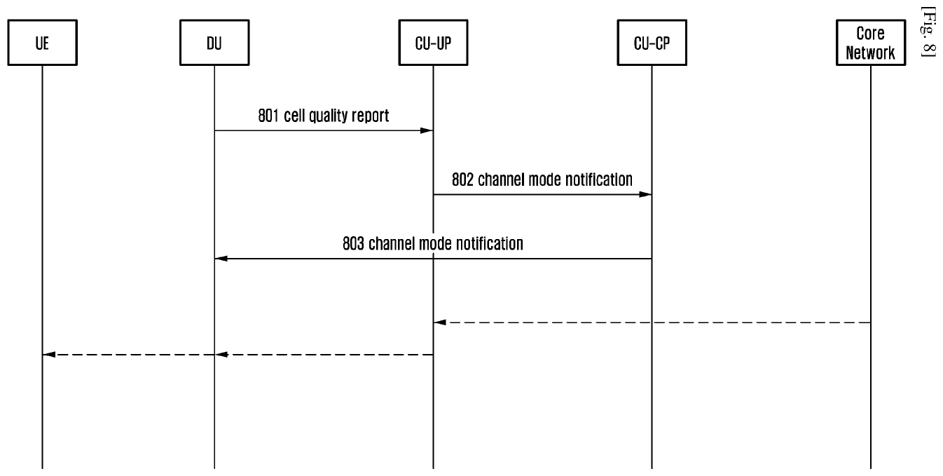

FIG. 8 is a schematic diagram of embodiment 6 of the present disclosure.

An embodiment of a method for switching multicast transmission mode according to the present disclosure is shown in FIG. 8 (embodiment 6). The multicast transmission mode may include a point-to-point transmission mode and a point-to-multipoint transmission mode, and it can be switched between the two modes. In this method, the CU-UP decides which mode is adopted, and informs the DU and the CU-CP of the mode. A detailed description of steps unrelated to the present disclosure is omitted here. The method comprises the following steps:

Step 801, the DU sends a cell signal quality report message to the CU-UP.

The cell signal quality can be indicated by various information, such as a reference signal receiving power (RSRP), a reference signal receiving quality (RSRQ), a data receiving success probability, times of data retransmission, and/or an indication indicating of signal quality (for example, good signal quality, poor signal quality or signal quality level), etc. The cell signal quality report can be sent to the CU-UP through the user plane. When the decision is made by the CU-UP, the CU-UP doesn't know the quality of a cell. If decision of the channel mode needs to refer to the cell signal quality, the DU can send the cell signal quality to the CU-UP through the user plane, or the CU-UP can get the cell signal quality from the message sent by the CU-CP.

Step 802, the CU-UP decides which channel mode is adopted to transmit the MBS, and sends channel mode notification information to the CU-CP, and the channel mode can indicate whether it is a point-to-point transmission mode or a point-to-multipoint transmission mode.

Step 803, the CU-CP may notify the DU of the decision. The CU-CP sends a message to the DU, and the message carries the identity of the MBS and the channel mode, and the channel mode can indicate whether it is a point-to-point transmission mode or a point-to-multipoint transmission mode.

Meanwhile, some of the steps of FIG. 8 described above may be omitted or preceded in advance according to another procedure. However, the procedures illustrated in FIG. 8 are exemplified to clearly convey what is intended to be described in the present disclosure. Accordingly, even if some procedures illustrated in FIG. 8 are omitted, those skilled in the art can sufficiently achieve the effects according to the object of the present invention by using the present disclosure.

With this embodiment, when the multicast transmission mode is switched, extra overhead of multicast data transmission can be avoided or reduced, utilization efficiency of access network resources and/or air interface resources can be improved, transmission delay can be reduced, data loss can be reduced, and delay caused by the switch of the transmission mode can be reduced.

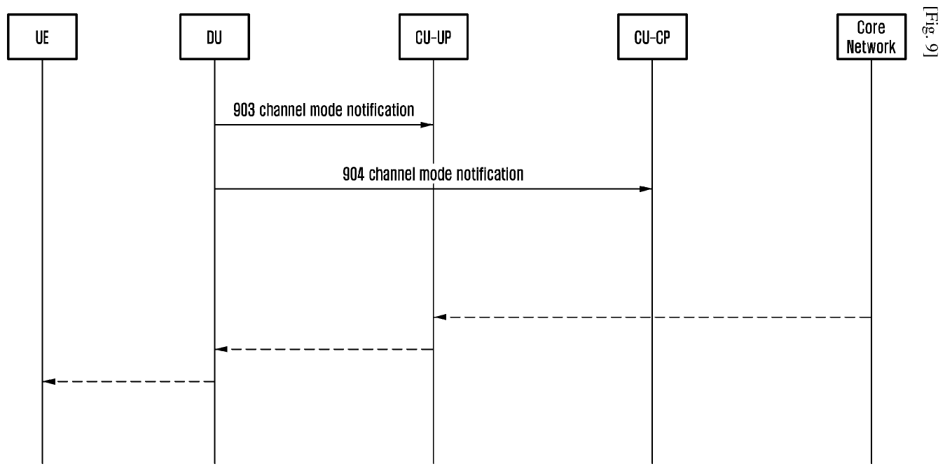

FIG. 9 is a schematic diagram of embodiment 7 of the present disclosure.

An embodiment of a method for switching multicast transmission mode according to the present disclosure is shown in FIG. 9 (embodiment 7). The multicast transmission mode may include a point-to-point transmission mode and a point-to-multipoint transmission mode, and it can be switched between the two modes. In this method, the DU decides which mode is adopted, and informs the CU-UP and the CU-CP of the mode. A detailed description of steps unrelated to the present disclosure is omitted here. The method comprises the following steps:

Step 901, the DU sends a channel mode notification message to the CU-UP.

According to the cell signal quality report and the number of users receiving the MBS, the DU decides which channel mode is adopted to send the MBS, and the DU sends a channel mode notification message to the CU-UP, which can be sent to the CU-UP through the user plane. The connection for the MBS has been established between the CU-UP and CU-CP. Through the connection, the DU informs the CU-UP of the channel mode. The cell signal quality can be indicated by various information, such as a reference signal receiving power (RSRP), a reference signal receiving quality (RSRQ), a data receiving success probability, times of data retransmission, and/or an indication indicating a signal quality (for example, a good signal quality, a poor signal quality or a signal quality level), etc.

Step 902, the DU decides which channel mode is adopted to transmit the MBS, and sends a channel mode notification message to the CU-CP.

With this embodiment, when the multicast transmission mode is switched, extra overhead of multicast data transmission can be avoided or reduced, utilization efficiency of access network resources and/or air interface resources can be improved, transmission delay can be reduced, data loss can be reduced, and delay caused by the switch of the transmission mode can be reduced.

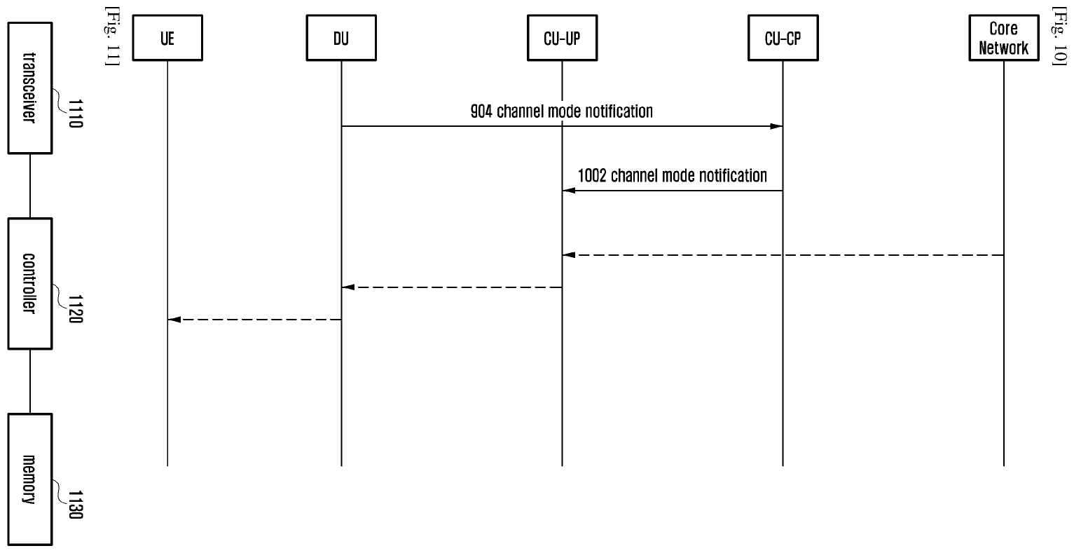

FIG. 10 is a schematic diagram of embodiment 8 of the present disclosure.

An embodiment of a method for switching multicast transmission mode according to the present disclosure is shown in FIG. 10 (embodiment 8). The multicast transmission mode may include a point-to-point transmission mode and a point-to-multipoint transmission mode, and it can be switched between the two modes. In this method, the DU decides which mode is adopted, and informs the CU-UP and the CU-CP of the mode. A detailed description of steps unrelated to the present disclosure is omitted here. The method comprises the following steps:

Step 1001, the DU sends a channel mode notification message to the CU-UP.

According to the cell signal quality report and the number of users receiving the MBS, the DU decides which channel mode is adopted to send the MBS, and the DU sends a channel mode notification message to the CU-UP, which can be sent to the CU-CP through an F1 interface. The message carries the identity of the MBS and the information on whether the channel mode is a point-to-point or a point-to-multipoint. The cell signal quality can be indicated by various information, such as a reference signal receiving power (RSRP), a reference signal receiving quality (RSRQ), a data receiving success probability, times of data retransmission, and/or an indication indicating a signal quality (for example, a good signal quality, a poor signal quality or a signal quality level), etc.

Step 1002, the CU-CP sends a channel mode notification message to the CU-UP.

With this embodiment, when the multicast transmission mode is switched, extra overhead of multicast data transmission can be avoided or reduced, utilization efficiency of access network resources and/or air interface resources can be improved, transmission delay can be reduced, data loss can be reduced, and delay caused by the switch of the transmission mode can be reduced.

FIG. 11 is a block diagram of a network equipment according to the present disclosure.

The network equipment can be used to realize a DU, a CU-UP, a CU-CP, a base station, a source base station, a target base station, a source DU, a source CU-UP, a source CU-CP, a target DU, a target CU-UP, a target CU-CP, etc. of the present disclosure. Referring to FIG. 11, a network equipment according to the present disclosure includes a transceiver 1110, a controller 1120, and a memory 1130. The transceiver 1110, the controller 1120, and the memory 1130 are configured to perform the operations of embodiments 1 to 10 of the present disclosure. Although the transceiver 1110, the controller 1120, and the memory 1130 are shown as separate entities, they may be implemented as a single entity, such as a single chip. The transceiver 1110, the controller 1120, and the memory 1130 may be electrically connected or coupled to each other. The transceiver 1110 can send signals to and receive signals from other network equipment, such as a UE, a base station or a core network node. The controller 1120 may include one or more processing units, and may control the network equipment to perform operations and/or functions according to one of the above embodiments. The memory 1130 may store instructions for implementing operations and/or functions of one of the above embodiments.

At this point, the method and equipment for multicast transmission of the present disclosure have been completed, which can avoid or reduce extra overhead of multicast data transmission, improve utilization efficiency of access network resources and/or air interface resources, reduce transmission delay, and reduce data loss and delay caused by transmission mode switch when the multicast transmission mode is switched.

### INDUSTRIAL APPLICABILITY

The present disclosure may be used when a mobile communication system provides a multicast service.

1. A method for multicast transmission by a first network equipment, comprising:
sending, to a second network equipment, a first message for requesting for establishing a multicast transmission radio channel between the first network equipment and the second network equipment; and
receiving, from the second network equipment, a second message in response to the first message.

2. The method of the claim 1, further comprising:
sending, to a third network equipment, a third message for requesting for establishing a multicast transmission radio channel between the first network equipment and the third network equipment; and
receiving, from the third network equipment, a fourth message in response to the third message.

3. The method of the claim 1, wherein the first message includes information about configuration of a point-to-point multicast transmission radio channel.

4. The method of the claim 1, wherein the first message includes information about configuration of a point-to-point multicast transmission radio channel and information about configuration of a point-to-multipoint multicast transmission radio channel.

5. The method of the claim 4, wherein the information about the configuration of the point-to-point multicast transmission radio channel and the information about the configuration of the point-to-multipoint multicast transmission radio channel have the same identity information.

6. The method of the claim 2, wherein the third message includes information about configuration of a point-to-point multicast transmission radio channel.

7. The method of the claim 2, wherein the third message includes information about configuration of a point-to-point and a point-to-multipoint multicast transmission radio channels.

8. The method of the claim 3, further comprising:
sending, to the second network equipment, a fifth message for requesting for establishing a point-to-multipoint multicast transmission radio channel between the first network equipment and the second network equipment;
wherein the fifth message includes information about configuration of the point-to-multipoint multicast transmission radio channel.

9. The method of the claim 6, further comprising:
sending, to the third network equipment, a six message for requesting for establishing a point-to-multipoint multicast transmission radio channel between the first network equipment and the third network equipment,
wherein the sixth message includes information about configuration of the point-to-multipoint multicast transmission radio channel.

10. A first network equipment for multicast transmission comprising:
a transceiver configured to transmit and receive signals; and
a processor configured to:
send, to a second network equipment through the transceiver, a first message for requesting for establishing a multicast transmission radio channel between the first network equipment and the second network equipment; and
receive, from the second network equipment through the transceiver, a second message in response to the first message.

11. The first network equipment of the claim 10, the processor further configured to:
send, to a third network equipment through the transceiver, a third message for requesting for establishing a multicast transmission radio channel between the first network equipment and the third network equipment; and
receiving, from the third network equipment through the transceiver, a fourth message in response to the third message.

12. The first network equipment of the claim 10, wherein the first message includes information about configuration of a point-to-point multicast transmission radio channel.

13. The first network equipment of the claim 10, wherein the first message includes information about configuration of a point-to-point multicast transmission radio channel and information about configuration of a point-to-multipoint multicast transmission radio channel.

14. The first network equipment of the claim 13, wherein the information about the configuration of the point-to-point multicast transmission radio channel and the information about the configuration of the point-to-multipoint multicast transmission radio channel have the same identity information.

15. The first network equipment of the claim 11, wherein the third message includes information about configuration of a point-to-point multicast transmission radio channel.

16. The first network equipment of the claim 11, wherein the third message includes information about configuration of a point-to-point and a point-to-multipoint multicast transmission radio channels.

17. The first network equipment of the claim 12, the processor further configured to:
send, to the second network equipment through the transceiver, a fifth message for requesting for establishing a point-to-multipoint multicast transmission radio channel between the first network equipment and the second network equipment,
wherein the fifth message includes information about configuration of the point-to-multipoint multicast transmission radio channel.

18. The first network equipment of the claim 15, the processor further configured to:
send, to the third network equipment through the transceiver, a six message for requesting for establishing a point-to-multipoint multicast transmission radio channel between the first network equipment and the third network equipment,
wherein the sixth message includes information about configuration of the point-to-multipoint multicast transmission radio channel.
